(19) United States
(12) Patent Application Publication
(10) Pub. No.: US 2011/0191602 A1
(43) Pub. Date: Aug. 4, 2011

(54) PROCESSOR WITH SELECTABLE LONGEVITY

(76) Inventors: David R. Bearden, Austin, TX (US); Ravindraraj Ramaraju, Round Rock, TX (US); Peter P. Abramowitz, Autstin, TX (US); William C. Moyer, Dripping Springs, TX (US)

(21) Appl. No.: 12/696,633

(22) Filed: Jan. 29, 2010

(51) Int. Cl. G06F 1/26

(52) U.S. Cl. 713/300

(57) ABSTRACT

A processor and method has at least one processor core for processing information and receives an operating voltage for powering circuitry of the processor. A selector receives a value indicative of a temperature within the processor and receives a value from a plurality of possible longevity values that each indicates a predetermined desired longevity of valid operation of the processor. An output provides an identifier that controls at least one of an operating voltage or an operating frequency of the processor, wherein the identifier provided is at least based on the value indicative of temperature and the predetermined desired longevity. A reliability storage device coupled to the selector stores the value from the plurality of possible longevity values that each indicates the predetermined desired longevity of valid operation of the processor.

### BACKGROUND OF THE INVENTION

1. Field of the Invention

This invention relates to data processors.

2. Description of the Related Art

Data processors include at least one processor core and are typically implemented on an integrated circuit. Data processors are powered by a power supply (e.g. a voltage regulator) at one or more operating voltages. Typically, higher operating voltages allow for higher operating frequencies.

Because data processors are implemented on integrated circuits, the operating temperature and the operating voltage of the integrated circuit may affect the longevity of the data processor. Typically, the higher the average operating temperature and/or operating voltage, the shorter the longevity (the useful life) of the integrated circuit. Higher operating temperatures and voltages are more likely to generate dielectric breakdown, electro migration, and Negative Bias Temperature Instability.

It is often desirable to operate a data processor at the highest possible operating frequency. However, operating a data processor at relatively high operating frequencies may correspondingly reduce the longevity of a device due to the greater amount of heat generated by the transistors of the device switching at faster speeds and the higher voltage needed to run at the elevated frequencies.

What is needed are improved systems for allowing flexibility of the use of a data processor.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a portion of a data processing system according to one embodiment of the present invention.

FIG. 2 is a graphical view of a memory according to one embodiment of the present invention.

FIG. 3 is state machine diagram according to one embodiment of the present invention.

FIG. 4 is a flow chart of the manufacture of a data processor according to one embodiment of the present invention.

FIG. 5 is a graphical view of a memory according to another embodiment of the present invention.

FIG. 6 is a graph showing maximum voltage to temperature curves for different longevity values according to one embodiment of the present invention.

FIG. 7 is a graph showing a maximum voltage curve versus an indication of temperature according to one embodiment of the present invention.

The use of the same reference symbols in different drawings indicates identical items unless otherwise noted. The Figures are not necessarily drawn to scale.

### DETAILED DESCRIPTION

The following sets forth a detailed description of a mode for carrying out the invention. The description is intended to be illustrative of the invention and should not be taken to be limiting.

Embodiments described relate to a data processor that is programmable to select a longevity (lifetime) of the device based on parameters such as an indication of operating temperature. Because a higher operating frequency can increase the operating temperature which can reduce the useful life of a data processor, the data processor is programmable to select a particular tradeoff between useful life and increased performance with higher operating frequencies and voltages. Such features may allow a particular model of data processor to be utilized for different applications and/or by different system manufactures. Such a feature may also provide for reduced production costs by reducing the number of models produced by a data processor supplier.

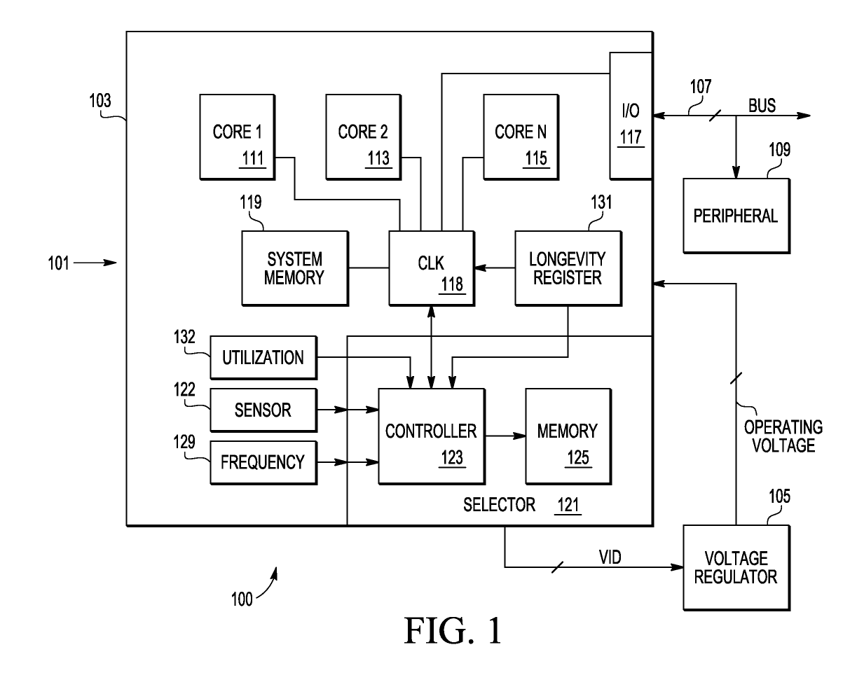

FIG. 1 is a block diagram of a data processing system 100. Data processing system 100 includes a data processor 103, which in one embodiment is implemented in an integrated circuit 101. System 100 also includes a bus 107 (or other type of system interconnect in other embodiments) for operably coupling processor 103 to peripheral devices 109 such as e.g. memory, key board, mouse, speaker, microphone, display, or bridge. In one embodiment, at least some devices or a portion some devices may be located on the same integrated circuit as processor 103.

System 100 includes a voltage regulator circuit 105 that receives a voltage identifier value (VID) from processor 103 and generates one or more operating voltages that corresponds to the VID value. Accordingly, processor 103 can control its operating voltage or operating voltages by adjusting the VID value. In some embodiments, the selector may provide multiple VID values, each for controlling the value of a different operating voltage supplied by regulator 105. In an embodiment that provides multiple VIDs, each VID may indicate a specific operating voltage for a particular processor core or a portion of the processor core. In one embodiment, the VID values are digital, but in other embodiment, the VID values are analog. An operating voltage is the voltage supplied by a regulator or other power source to circuitry for powering the circuitry. In one embodiment, components of regulator 105 are not located on the same integrated circuit 101 as processor 103. However in other embodiments, at least some those components of regulator 105 are located on integrated circuit 101.

In the embodiment shown, processor 103 includes a number of processor cores 111, 113, and 115. A processor core includes an execution unit for performing processing operations as per executable code. Each core of processor 103 is of a particular data processing architecture type such as e.g. Power PC, x86, SPARC, MIPS, or an ARM architecture. Each core also is of a particular processor configuration such as e.g. a general purpose processor, a digital signal processor, an applications specific processor, or a network packet inspection processor. In one embodiment, the cores have identical configurations and architectures, but in other embodiments, the cores have different configurations and architectures from each other. For example, one of the cores may be a digital signal processor and the other cores may be general purpose processor of a different architecture.

In the embodiment shown, the maximum operating frequency of at least one core is controlled by the operating voltage, although in other embodiments, the frequency may be independently controlled by a clock circuit 118. Processor 103 includes a system memory 119 that is operably coupled to the cores via a processor bus (not shown). Processor 103 also includes I/O circuitry 117 for coupling to bus 107. Processor 103 includes a clock circuit 118 for providing clock signals to the circuitry of processor 103 including to cores 111, 113, and 115, and memory 119. In one embodiment, each clock signal controls the operating frequency of its respective core. Processor 103 may have other configurations in other embodiments including having other circuits such as e.g. a cache.

Processor 103 includes a system for controlling the operating voltage or voltages by providing a VID indicative of the desired operating voltage or voltages to supply the circuitry of processor 103 including the cores. The operating voltage is limited as a function of a temperature indication to meet a selectable longevity requirement that has been programmed into longevity register 131.

In the embodiment shown, selector 121 includes controller 123 for controlling the operation of selector 121 and a memory 125 for storing sets of VID values that correspond to a set of temperature indication values for each longevity value.

Controller 123 is coupled to temperature sensor 127 for receiving an indication of the junction temperature of processor 103. In one embodiment, sensor 127 includes a thermal monitor (not shown) whose output is proportional to the temperature of the integrated circuit. In the embodiment shown sensor 127 is located in the same integrated circuit 101 as data processor 103. However in other embodiments, sensor 127 may be located off chip. Also in other embodiments, processor 103 includes multiple temperature sensors located throughout processor 103, each providing an indication to controller 123. In one embodiment, each core includes a temperature sensor.

In other embodiments, controller 123 may utilize other values other than a temperature measurement as an indication of the operating temperature. For example, the temperature indication may correspond to a circuit usage value of the circuitry of processor 103. With some systems, the number of cores operating at one time may be indicative of the operating temperature of the processor at that time. Such a value may be generated by the operating system of system 100 and stored in utilization register 132. As the number of devices are turned on or off, the value would change, indicating a higher or lower operating temperature.

Frequency register 129 includes an indication of a desired operating frequency or frequencies for the cores of processor 103. In one embodiment, the desired operating frequency is written to register 129 by the operating system of system 100.

In other embodiments, processor 103 implements a number of performance states. Each performance state includes an associated frequency at which a processor core or cores will operate. The operating frequencies switch with a change in performance states. In one embodiment, the value in frequency register 129 is written by circuitry that reads the performance state and the registers that store the frequency corresponding the performance state. In other embodiments, the controller 123 receives an indication of the performance states and determines the corresponding frequency of the performance state. In one embodiment, the frequencies corresponding the performance states are programmable. In one embodiment, the corresponding frequencies to performance states would be programmed in memory 125 or reflected in the information programmed in memory 125. Controller 123 would then provide a frequency identifier to clock circuit 118 to control an operating frequency provided by the clock circuit.

In one embodiment, the longevity values are programmed by programming one time programmable devices (e.g. fuses, electrically programmable read only memory, or an erasable EPROM that has been configured to be written only once) to store the longevity values. A longevity value is indicative of the desired longevity of the device. Based on the longevity of the device, the selector will provide a VID (and frequency identifier in some embodiments) that will generate or allow an operating frequency that will enable the processor to perform for the desired longevity. In some embodiments, register 131 includes the one time programmable devices. In other embodiments, register 131 is a volatile memory, where the operating system of system 100 reads the values of the one time programmable devices (either on integrated circuit 101 or off chip) and writes those values to register 131 during start up.

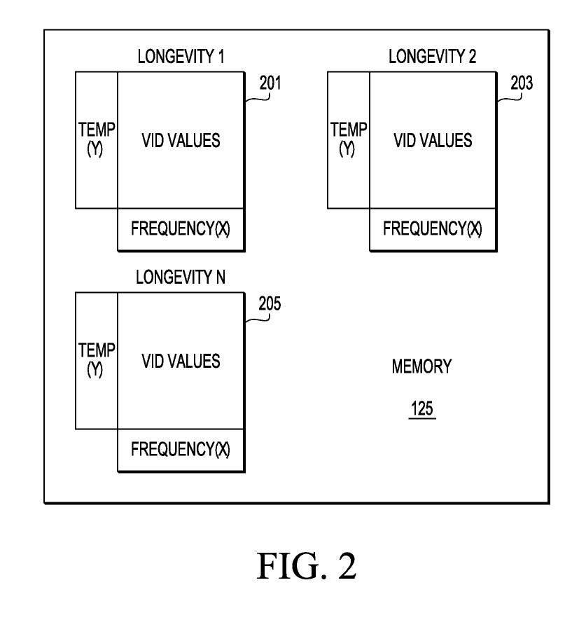

FIG. 2 shows graphical representation of data stored in memory 125 according to one embodiment of the present invention. In the embodiment shown, memory 125 includes a table associated with each longevity value. For example, table 201 is associated with longevity value 1, table 203 is associated with longevity value 2, and table 205 is associated with longevity value N. Each table includes VID values that are associated with a particular frequency of frequencies (X axis) and a particular temperature or temperature range of temperatures (Y axis).

In operation, controller 123 receives the longevity value to determine which table of tables 201, 203, and 205 is used to select the VID values. With the appropriate table selected, controller 123 selects the VID value corresponding to the temperature value range as measured by the one or more temperature sensors or as indicated by the configuration indication, and the frequency indication. In an embodiment where each core includes its own temperature sensor, the table selected by the longevity value would be used to select the VID value for the core based on the measured temperature of the sensor associated with the core.

Accordingly, by providing the ability to selectively program a longevity value from a number of possible longevity values, a processor (or core of a processor) can be configured to operate at different operating voltages for a specific temperature or temperature range in order to order to achieve to the desired longevity. For example, if the desired longevity is 3 years, processor 103 can operate at higher operating voltage (and therefore a higher operating frequency) for a given temperature than a processor whose longevity value is longer (e.g. 5 years, 7 years, 9 years, or 15 years). For example, for a temperature of 105 C, a processor may operate at 1.3 volts for a 5 year longevity value versus 1.0 volts for a processor with a longevity value of 8 years. Operating at a higher voltage in some embodiments, allows the processor to operate at a higher frequency.

Memory 125 may store the VID values based on other configurations. For example, memory 125 may includes a number of tables for each desired frequency, where each table includes VID values associated with a particular temperature range and longevity value. In other embodiments, the memory includes a table for each temperature range that includes VID values associated with a particular desired frequency and longevity value. The data in memory 125 may be stored in any number of different ways that are conventional to data storage devices including the use of compression techniques.

The number of temperature values, frequency values, and longevity values may vary with different embodiments. For example, one embodiment may include just two temperature ranges (over 105 C and under 105 C). Also, the frequency values may be for a given frequency range.

In another embodiment, the information shown in FIG. 2, may be implemented in hardwired circuitry. For example, the VID values may be obtained from circuitry implementing a formula whose inputs are desired frequency and temperature indication.

In one embodiment, clock circuit 118 and controller 123 are coupled to change the operating voltage and operating frequency in an ordered manner for processor reliability. In one embodiment for an increase in operating frequency, the operating voltage would first be increased by selector 121 and then clock circuit 118 would increase the operating frequency. Likewise, when decreasing the operating frequency, clock circuit 118 decreases the operating frequency first and then controller 123 lowers the voltage by changing the VID value. In one embodiment, selector 121 controls clock circuit 118, but in other embodiments, clock circuit 118 controls selector 121. In another embodiment, both circuits would be controlled by an other circuit or by the operating system for processor frequency/voltage coordination.

Also in other embodiments, the VID value would be provided internally (e.g. to a register) such that the operating system or other system controlling operating frequency would read the corresponding VID value and alter the operating frequency accordingly.

Still in other embodiments, processor 103 would include a frequency monitoring circuitry (e.g. that includes a ring oscillator circuit) that monitors operating frequency. If the operating frequency is less than the desired frequency, the value for the desired frequency provided to selector 121 is increased so as to increase the operating voltage.

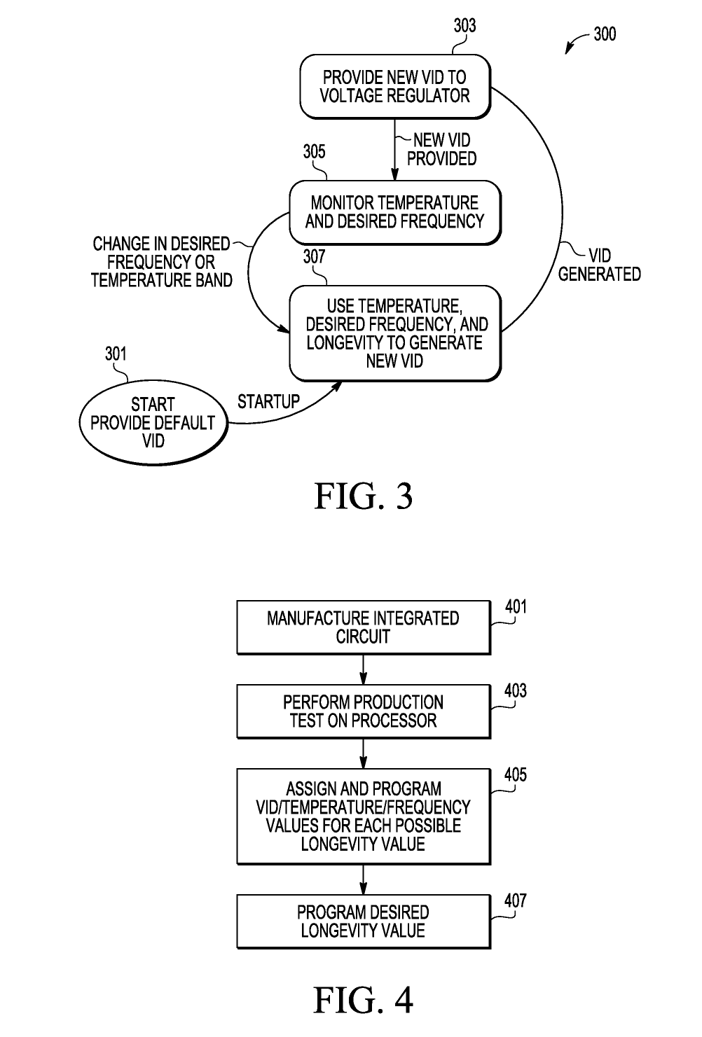

FIG. 3 is a state diagram implemented by selector 121 for controlling the voltage VID values provided to regulator 105. At startup (state 301) selector 121 provides a default VID value to indicate a default operating voltage. After startup, the control transitions to state 307 where it uses the indicated temperature measurement, the desired frequency, and the longevity value to produce a new VID value (or multiple VID values where there are multiple operating voltages provided). Upon generating the VID value in state 307, the selector 121 provides the voltage value to voltage regulator 105 in state 303. In some embodiments, in state 303, controller 123 signals the clocking circuit to reduce the frequency of the clock signal to the core or circuitry of processer 103 if the operating voltage to those circuits is being reduced and waits until the frequency has been reduced before providing the new VID value to voltage regulator 105.

After providing the new VID value to regulator 105 in state 303, control transfers to state 305 where it monitors an indication of temperature from sensor 127 and desired frequency from register 129. If there is a change in either of these, control transfers to state 307 where it generates a new VID value.

In other embodiments, a state machine may have other configurations. In some embodiments, where regulator 105 produces multiple voltages, controller 123 may institute a state machine for each separate voltage domain. In another embodiment, controller 123 may monitor and generate a new operating voltage for each operating voltage being provided in response to a change in either temperature or desired frequency. Still in other embodiments, control of the VID generation may be made by other techniques other than a state machine. In some embodiments, controller may be implemented as hardwired logic, but in other embodiments, it may be implemented by a processor core executing programmed code.

FIG. 4 is a flow diagram illustrating selected operations in the manufacture of an integrated circuit including a processor according to one embodiment of the present invention.

In operation 401, an integrated circuit such as integrated circuit 101 that includes a data processor such as data processor 103 is manufactured according to conventional integrated circuit manufacturing processes such as performing semiconductor manufacturing processes on a semiconductor wafer.

In operation 403, production testing is performed on the data processor. Production testing may include performing operating voltage to operating frequency tests on the processor to determine rated frequencies of the data processor. Alternate or additional tests may be performed to determine the frequency versus voltage versus temperature characteristics of the integrated circuit 101 or frequency monitoring circuitry in the processor 103. Examples of these tests include AC scan, logic or array BIST, and ring oscillator performance test of the frequency monitoring circuitry.

In operation 405, VID/temperature/frequency values for all possible longevity values such as those shown in FIG. 2 are programmed into memory 125. In one embodiment, the values programmed into memory 125 are based on the results of the production tests in operation 403.

In operation 407, the desired longevity value is programmed into register 131 based on a customer's desire for longevity. In some embodiments, operation 407 maybe done by the IC manufacturer, may be done by the system manufacturer, or may be done by the customer. Still in some embodiments, operation 407 may be performed by the final system during operation, such as during an initialization of the system.

In one embodiment, data of operation 405 may be loaded into memory 125 during the manufacture of the processor. For example, the data of the tables of FIG. 2 may be programmed in firmware or ROM during manufacture of the data processor. In some embodiments, the data processor may include a performance register of one time programmable devices that is programmed based on the results of testing operation 403. For example, based on the testing in operation 403, the data processor may be rated at a particular operating frequency based on a number of operating frequency ranges (e.g. 1.2, 1.0, 0.8 GHz). Controller 123 would use this performance information along with the longevity information and temperature information in providing the VID values. An integrated circuit may be manufactured or configured by different processes in other embodiments.

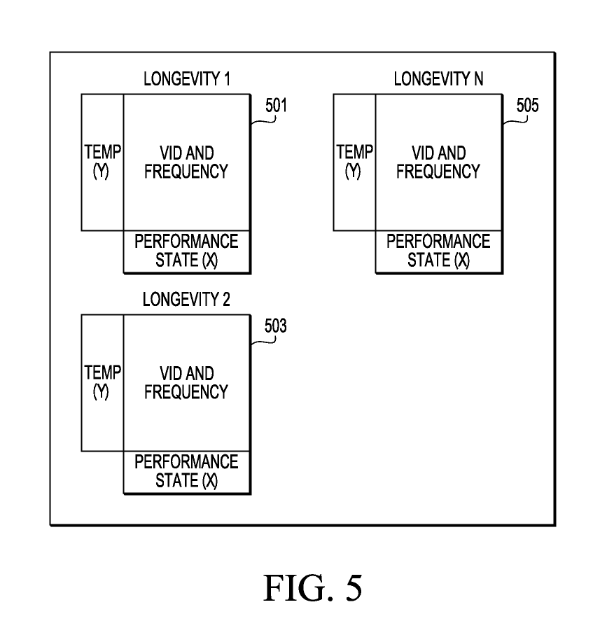

FIG. 5 shows graphical representation of data stored in memory 125 according to another embodiment of the present invention. In the embodiment of FIG. 5, memory 125 stores tables 501, 505, and 503 of VID values and operating frequency identifier values for three different longevity values. The specific table used to provide the VID value and operating frequency identifier value are dependent upon the longevity value stored in register 131.

During operation, controller 123 reads a desired performance state from utilization register 132 and the temperature indication and selects an operating frequency identifier value and VID value from the table as determined by the longevity value. The VID value is then outputted to voltage regulator 105 and the operating frequency indentifier value is outputted to clock circuit 118.

In one embodiment, a performance state is a value provided by the operating system that indicates a particular performance level of a processor core, processor cores, or of the processor in general. For example, during an operation when all cores of data processor 103 are executing, an operating system may submit a high performance state to controller 123 where all of the cores are operating at the highest possible operating frequency. However, if the system is in a low power mode or in a power saving mode, then the operating system may request a lower performance state which translates into a lower operating frequency. The VID values would be selected which enable the core to operate at the desired operating frequency provided to clock circuit 118. In the embodiment shown, the possible operating frequencies and operating voltages assigned to a different performance state is modifiable based upon the desired longevity of the part.

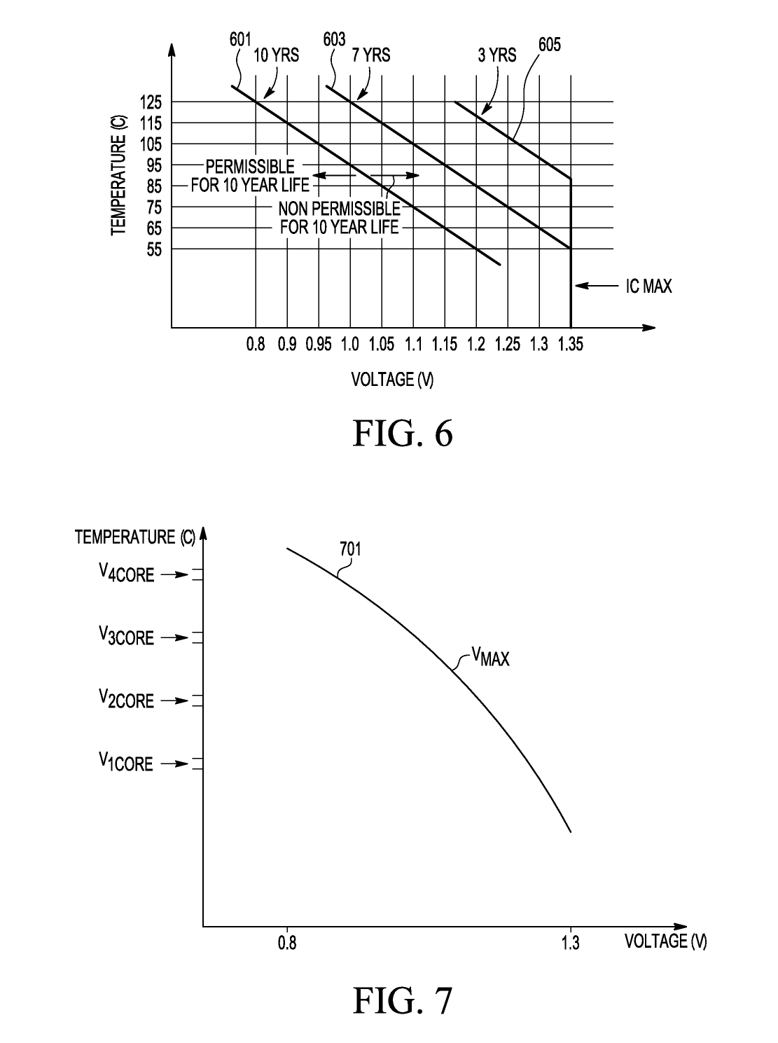

FIG. 6 is a graph representation showing the relationship between operating temperature and a maximum allowable voltage for different longevity values. In the graph of FIG. 6, the X axis is the operating voltage and the Y axis is measured operating temperature in Celsius. Lines 601, 603, and 605 represent the maximum voltage allowed for a measured temperature for each longevity value respectively. In the embodiment shown, line 601 represents the maximum voltage per temperature for a 10 year longevity value, line 603 represents the maximum voltage per temperature for a 7 year longevity value, and line 605 represents the maximum voltage per temperature for a 3 year longevity value. A maximum voltage for a given temperature indicates the maximum voltage that can be applied at that temperature without reducing the useful live of the integrated circuit below the selected longevity. In the embodiment shown, voltages located to the left of each line represents operating voltages that are allowable at a given temperature, and voltages to the right of each line are voltages that are not allowable (which may cause the part not to operate for its selected useful life).

As shown in the graph, the maximum voltage that can be supplied to the data processor (IC max) is 1.35 volts. If a ten year longevity is desired, then for a 95 degree operating temperature, the maximum permitted voltage is 1.0 volt. If a seven year longevity is desired, then for a 95 degree operating temperature, the maximum permitted voltage is 1.15 volts. If 3 year longevity is desired, then for a 95 degree operating temperature, the maximum permitted voltage is 1.32 volts.

Because the curves are implemented in the data of memory 125, the VID value provided by selector 121 will not indicate a higher voltage than allowed by the selected curve for a given measured temperature. However, a VID value for a voltage less than the maximum temperature may be outputted if the desired frequency can be obtained at a lower operating voltage.

Referring to the embodiment of FIG. 5, the curves of lines 601, 603, and 605 are enforced by the data of tables 501, 503, and 505 respectively. Thus, for the highest performance state, selector 121 may provide the highest clock signal allowable by the maximum voltage for a given measured temperature based on the desired longevity. However, a lower operating voltage may be provided, depending upon the desired performance state.

Although not shown, a maximum frequency curve versus indicated temperature for each longevity value may be enforced by selector 121. For example, at a particular measured temperature, a maximum operating frequency allowable for a 3 year desired longevity may be higher than for a 5 year desired longevity. Thus, the information of memory 125 is configured to enforce maximum frequency curves as well.

FIG. 7 sets for a graph illustrating the maximum operating voltage for a four core data processor as a function of temperature. In some embodiments, the operating temperature at a particular time of an integrated circuit with multiple cores is dependent upon the number of cores operating at that time. Typically, the more cores operating at one time generally means that a greater number of transistors are switching during that time. In FIG. 7, the Y axis indicates the relationship to operating temperature of an integrated circuit based on the number of cores operating. T4core represents the approximate range in temperature where 4 cores are operating, T3core represents the approximate range in temperature where 3 cores are operating, T2core represents the approximate range in temperature where 2 cores are operating, and T1core represents the approximate range in temperature where 1 core are operating.

Line 701 indicates a maximum operating voltage allowable per operating temperature to ensure a particular longevity of the device. Because the number of operating cores translates to a particular temperature or range of operating temperatures, the maximum operating voltage allowable is dependent upon the number of cores operating at a particular time. Accordingly, the number of cores operating at one time can be used by selector 121 as an indication of the operating temperature of a device. Thus, the VID values and operating frequency values can be selected based on the number of cores operating. Information regarding the number of cores operating may be written to a utilization register 132 by the operating system.

Providing a system that allows for operating voltage (and/or operating frequency) to be selected based on a programmable longevity value provides for a data processing system that can be flexibly programmed based on the system manufacture's needs. For example, some system manufactures may use a data processor in an application (such as a cellular phone) that will have a relatively short useful life. Hence increased performance can be implemented at the expense of the useful life of the processor. Other system manufactures (such as automobile manufactures) may use the processor in a system that has a relatively long useful life. Thus, it is important for the processor to operate at a level that will ensure a long operating life. By providing a longevity value, a data processing manufacture can use one processor design for multiple system customers.

In some embodiments, selector 121 provides operating frequency identifier or identifiers and does not provide voltage identifiers to a voltage regulator.

The steps of “providing” in the method claims can be read on possession or use of a processor with the features of the claims.

In one embodiment, a processor includes at least one processor core for processing information. The processor receives an operating voltage for powering circuitry of the processor. The processor includes a selector configured to receive at least a value indicative of a temperature within the processor and configured to receive a value from a plurality of possible longevity values that each indicate a predetermined desired longevity of valid operation of the processor. The selector is configured to provide an identifier selected from a plurality of identifiers. The identifier controls at least one of a group consisting of the operating voltage and an operating frequency of the processor. The identifier provided is selected from the plurality of identifiers at least based on the value indicative of temperature and the predetermined desired longevity. The processor includes a storage device coupled to the selector for storing the value from the plurality of possible longevity values that each indicate the predetermined desired longevity of valid operation of the processor.

In another embodiment, a method includes providing a processor with at least one processor core for processing information by the processor when powered including being powered by at least one operating voltage. The method includes providing a selector of the processor configured to receive a temperature indication representing a temperature associated with the processor. The selector is configured to receive a selected longevity value from a plurality of possible longevity values indicating a desired longevity of valid operation of the processor. The selector of the processor has an output to provide an identifier selected from a plurality of identifiers based at least upon the temperature indication and the selected longevity value, the identifier controlling at least one of a group consisting of an operating voltage of the processor and an operating frequency of the processor.

In another embodiment, a processor includes a plurality of processor cores. Each of the plurality of processor cores processing information when being powered by an operating voltage. The processor includes a temperature sensor configured to provide a value indicative of a temperature within the processor. The processor includes a selector configured for receiving the value indicative of the temperature within the processor and configured for receiving a longevity value of a plurality of possible longevity values that each indicate a predetermined desired longevity of valid operation of the processor. The selector configured to provide at least one of a group consisting of a voltage identifier that controls an operating voltage of circuitry of at least one of the plurality of processor cores and a frequency identifier that controls an operating frequency of at least one of the plurality of processor cores. The processor includes a one time programmable storage device for storing the longevity value.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. A processor, comprising:
at least one processor core for processing information, the processor receiving an operating voltage for powering circuitry of the processor;
a selector configured to receive at least a value indicative of a temperature within the processor and configured to receive a value from a plurality of possible longevity values that each indicate a predetermined desired longevity of valid operation of the processor, the selector configured to provide an identifier selected from a plurality of identifiers, wherein the identifier controls at least one of a group consisting of the operating voltage and an operating frequency of the processor, wherein the identifier provided is selected from the plurality of identifiers at least based on the value indicative of temperature and the predetermined desired longevity; and
a storage device coupled to the selector for storing the value from the plurality of possible longevity values that each indicate the predetermined desired longevity of valid operation of the processor.

2. The processor of claim 1 wherein the selector is configured to receive a value indicating a desired frequency of operation of the at least one processor core, wherein the identifier provided is selected from the plurality of identifiers at least based on the desired frequency.

3. The processor of claim 1 wherein the identifier controls the operating voltage.

4. The processor of claim 1 wherein the identifier controls an operating frequency of a core of the processor.

5. The processor of claim 1 wherein the selector further comprises:
a memory comprising a plurality sets of identifiers, wherein a first set of the plurality of sets is correlated to a first longevity of the processor and a second set of the plurality of sets is correlated to a second longevity of the processor that is less than the first longevity of the processor.

6. A data processing system comprising the processor of claim 1, wherein the identifier controls the operating voltage, the data processing system further comprising:
a voltage regulator coupled to the selector to receive the identifier and coupled to the processor to provide the operating voltage.

7. The processor of claim 1 wherein:
the selector receives an indication of a desired performance of at least one processor core and outputs the identifier to set an operating frequency for the at least one processor core, wherein the identifier to set an operating frequency is at least based on the value indicative of temperature, the predetermined desired longevity, and the indication of desired performance.

8. The processor of claim 1 wherein the at least one processor core further comprises a plurality of individual processor cores, each of the plurality of individual processor cores is powered by a different operating voltage whose value is determined by an identifier from a plurality of identifiers provided by selector;
wherein each value is at least based on the value indicative of temperature and the predetermined desired longevity.

9. The processor of claim 1 wherein the selector configured to provide a second identifier, wherein the identifier controls the operating voltage and the second identifier controls an operating frequency of a core of the processor.

10. The processor of claim 1 further comprising:
a temperature sensor located on a same integrated circuit as the processor, wherein the value indicative of temperature is based on an output of the temperature sensor.

11. A method comprising:
providing a processor with at least one processor core for processing information by the processor when powered including being powered by at least one operating voltage;
providing a selector of the processor configured to receive a temperature indication representing a temperature associated with the processor, wherein the selector is configured to receive a selected longevity value from a plurality of possible longevity values indicating a desired longevity of valid operation of the processor; and
wherein the selector of the processor has an output to provide an identifier selected from a plurality of identifiers based at least upon the temperature indication and the selected longevity value, the identifier controlling at least one of a group consisting of an operating voltage of the processor and an operating frequency of the processor.

12. The method of claim 11 wherein the selector is configured to receive an indication of desired performance of the processor, wherein the identifier is selected from a plurality of identifiers at least based upon the indication of desired performance.

13. The method of claim 12 wherein the processor stores a plurality of sets, each of the plurality of sets including a plurality of identifiers, each set of the plurality of sets being correlated with a longevity value from the plurality of possible longevity values indicating a desired longevity of valid operation.

14. The method of claim 11 wherein identifier is for controlling an operating voltage of the processor.

15. The method of claim 11 further comprising:
providing at least one voltage regulator coupled to the processor, the at least one voltage regulator receiving the identifier and providing the operating voltage in response thereto.

16. The method of claim 11 wherein identifier is for controlling an operating frequency of the processor.

17. A processor, comprising:
a plurality of processor cores, each of the plurality of processor cores processing information when being powered by an operating voltage;
a temperature sensor configured to provide a value indicative of a temperature within the processor;
a selector configured for receiving the value indicative of the temperature within the processor and configured for receiving a longevity value of a plurality of possible longevity values that each indicate a predetermined desired longevity of valid operation of the processor, the selector configured to provide at least one of a group consisting of a voltage identifier that controls an operating voltage of circuitry of at least one of the plurality of processor cores and a frequency identifier that controls an operating frequency of at least one of the plurality of processor cores; and
a one time programmable storage device for storing the longevity value.

18. The processor of claim 17 wherein the selector comprises a memory for storing sets of a plurality of voltage identifiers, each of the plurality of voltage identifiers of each set being correlated with a temperature or temperature range, wherein each set corresponds to a longevity value of the plurality of possible longevity values.

19. The processor of claim 18 wherein at least some values of voltage identifiers of a first set of the plurality corresponding to a lower time length longevity are higher in value than values of voltage identifiers of a second set of the plurality corresponding to a higher time length longevity for the same temperatures or same temperatures ranges.

20. A data processor of claim 17 wherein the selector provides the voltage identifier.
